(19) United States
(12) Patent Application Publication
(10) Pub. No.: US 2026/0127817 A1
(43) Pub. Date: May 7, 2026

(54) VIDEO CONFERENCE SYSTEM AND THREE-DIMENSIONAL MODELING METHOD USING THE SAME

(71) Applicant: Acer Incorporated, New Taipei City (TW)

(72) Inventors: Chi-Kang LEE, New Taipei City (TW); Wen-Cheng HSU, New Taipei City (TW); Shih-Hao LIN, New Taipei City (TW); Chieh-Sheng WANG, New Taipei City (TW); Sergio CANTERO CLARES, New Taipei City (TW)

(73) Assignee: Acer Incorporated, New Taipei City (TW)

(21) Appl. No.: 19/292,600

(22) Filed: Aug. 6, 2025

(30) Foreign Application Priority Data
Nov. 1, 2024 (TW) 113141842

(51) Int. Cl. G06T 17/00

(52) U.S. Cl. CPC G06T 17/00

(57) ABSTRACT

A video conference system and a three-dimensional modeling method using the same are provided. The three-dimensional modeling method of the video conferencing includes the following steps. A portable image capture device obtains a plurality of photos of an object and records a plurality of modeling information corresponding to the photos. The portable image capture device transmits the photos and the modeling information to a first electronic device. The first electronic device encodes each of the modeling information into each of the photos through a hidden watermark. The first electronic device transmits the photos with the hidden watermarks to a second electronic device. The second electronic device decodes each of the hidden watermarks of each of the photos to obtain each of the modeling information. The second electronic device creates a three-dimensional model according to the photos and the modeling information. The second electronic device displays the three-dimensional model.

This application claims the benefit of Taiwan application Serial No. 113141842, filed Nov. 1, 2024, the disclosure of which is incorporated by reference herein in its entirety.

### TECHNICAL FIELD

The disclosure relates in general to a conference system and a three-dimensional modeling method for video conference using the same.

### BACKGROUND

With the advancement of video technology, people can communicate and discuss over long distances through video conferencing software. During a video conference, as long as the speaker turns on the camera, his or her image can be transmitted to the participants.

During the video conference, the presenter can show an object, an indoor environment or a beautiful view through the camera. In order to let the attendees see the object in its entirety, the presenter can rotate the object or shoot around it. However, even if the presenter tries his best to shoot all the details of the object, the attendees may still want to take a closer look at a certain angle, but they cannot keep asking the presenter to show the object again. Therefore, researchers are working on developing a technology that allows attendees to actively adjust the angle without asking the presenter to show it again.

### SUMMARY

The disclosure is directed to a three-dimensional modeling method for video conference using the same. During the video conference, the speaker's first electronic device will display photos of an object from all directions and transmit them to the attendees'second electronic devices through the network. In addition, modeling information is added to the photos, allowing the second electronic device to quickly build a three-dimensional model. Using the three-dimensional model, attendees could rotate the object with the mouse or keyboard to fully see the appearance of the object.

According to one embodiment, a three-dimensional modeling method for a video conference is provided. The three-dimensional modeling method for the video conference includes the following steps: obtaining a plurality of photos of an object and recording a plurality of modeling information corresponding to the photos by a portable image capture device; transmitting the photos and the modeling information to a first electronic device by the portable image capture device; encoding each of the modeling information into each of the photos through a hidden watermark by the first electronic device; transmitting the photos with the hidden watermarks to a second electronic device by the first electronic device; receiving the photos with the hidden watermarks by the second electronic device; decoding each of the hidden watermarks of each of the photos to obtain each of the modeling information by the second electronic device; creating a three-dimensional model according to the photos and the modeling information by the second electronic device; and displaying the three-dimensional model by the second electronic device.

According to another embodiment, a video conference system is provided. The video conference system includes a portable image capture device, a first electronic device and a second electronic device. The portable image capture device is used for obtaining a plurality of photos of an object and recording a plurality of modeling information corresponding to the photos. The first electronic device includes a first transmission unit and a watermark encoding unit. The first transmission unit is used for receiving the photos and the modeling information from the portable image capture device. The watermark encoding unit is used for encoding each of the modeling information into each of the photos through a hidden watermark. The first transmission unit is further used for transmitting the photos with the hidden watermarks. The second electronic device includes a second transmission unit, a watermark decoding unit, a modeling unit, an operating unit and a display unit. The second transmission unit is used for receiving the photos with the hidden watermarks. The watermark decoding unit is used for decoding each of the hidden watermarks of each of the photos to obtain each of the modeling information. The modeling unit is used for creating a three-dimensional model according to the photos and the modeling information. The operating unit is used for providing a viewing angle. The display unit is used for displaying the three-dimensional model according to the viewing angle.

### BRIEF DESCRIPTION OF THE DRAWINGS

FIG. 1 illustrates an example of a three-dimensional modeling method for a video conference of an embodiment of the present disclosure.

FIG. 2 is a block diagram of a video conference system according to an embodiment of the present disclosure.

FIGS. 3a to 3B are flowcharts of the three-dimensional modeling method for the video conference according to an embodiment of the present disclosure.

FIG. 4 illustrates the step S240 and the step S250.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The technical terms in this specification refer to the customary terms in the technical field. If some terms are explained or defined in this specification, the interpretation of these terms shall be based on the explanation or definition in this specification. Each embodiment of the present disclosure has one or more technical features. Under the premise of possible implementation, a person with ordinary knowledge in the technical field can selectively implement some or all of the technical features in any embodiment, or selectively combine some or all of the technical features in these embodiments.

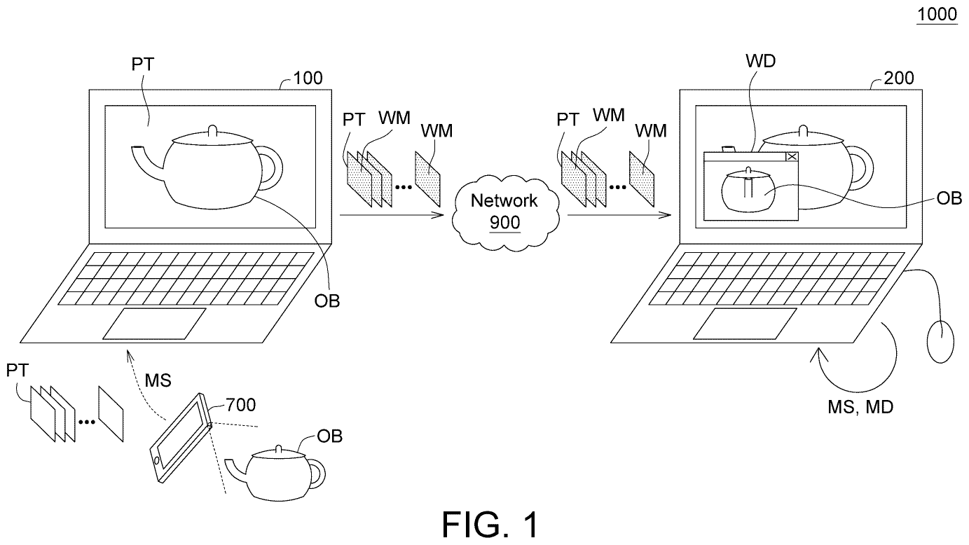

Please refer to FIG. 1, which illustrates an example of a three-dimensional modeling method for a video conference of an embodiment of the present disclosure. During the video conference, a first electronic device 100 of the presenter and a second electronic device 200 of the participant could conduct long-distance video communication and discussion through a network 900. The speaker's first electronic device 100 will display photos PT of an object OB in various directions and transmit them to the attendee's second electronic device 200 through the network 900. In the independent window WD, the attendee could rotate the object OB by mouse or keyboard to fully see the appearance of each face of the object OB.

Regardless of the rotation angle of the object OB by the presenter, the attendees could adjust and rotate the object OB to select the part/position of the object OB that they are interested in. Therefore, the attendees could experience the feeling of holding the object OB in their hands and looking at it carefully, and being immersed in the scene.

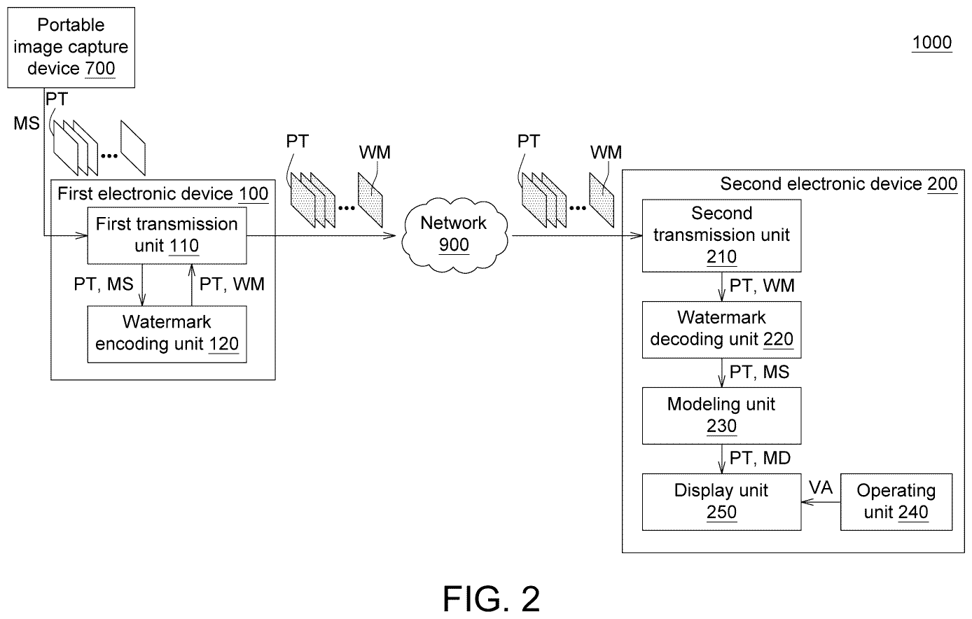

Please refer to FIG. 1 and FIG. 2. FIG. 2 is a block diagram of a video conference system 1000 according to an embodiment of the present disclosure. The video conference system 1000 includes a portable image capture device 700, a first electronic device 100 and a second electronic device 200. The portable image capture device 700 is used to perform an image capture process.

The first electronic device 100 includes a first transmission unit 110 and a watermark encoding unit 120. The second electronic device 200 includes a second transmission unit 210, a watermark decoding unit 220, a modeling unit 230, an operating unit 240 and a display unit 250. The first transmission unit 110 and the second transmission unit 210 are used to perform a data transmission process, such as a wireless transmission module or a wired transmission module.

The watermark encoding unit 120 is used for encoding. The watermark decoding unit 220 is used for decoding. The modeling unit 230 is used for modeling.

The watermark encoding unit 120, the watermark decoding unit 220 and/or the modeling unit 230 is, for example, a circuit, a circuit board, a storage device storing program code or a chip. The chip is, for example, a central processing unit (CPU), or other programmable general-purpose or special-purpose micro control unit (MCU), a microprocessor, a digital signal processor (DSP), a programmable controller, an application specific integrated circuit (ASIC), a graphics processing unit (GPU), an image signal processor (ISP), an image processing unit (IPU), an arithmetic logic unit (ALU), a complex programmable logic device (CPLD), a field programmable gate array (FPGA) or other similar components or combinations of the above components.

The operating unit 240 is used for user control, such as a mouse, a touch screen, a touch pad or a stylus. The display unit 250 is used to display various information, such as a liquid crystal display screen or an OLED screen.

In this embodiment, a plurality of modeling information MS is added to the photos PT so that the second electronic device 200 could quickly create a three-dimensional model MD. The following is a flowchart that describes the operation of each component in detail.

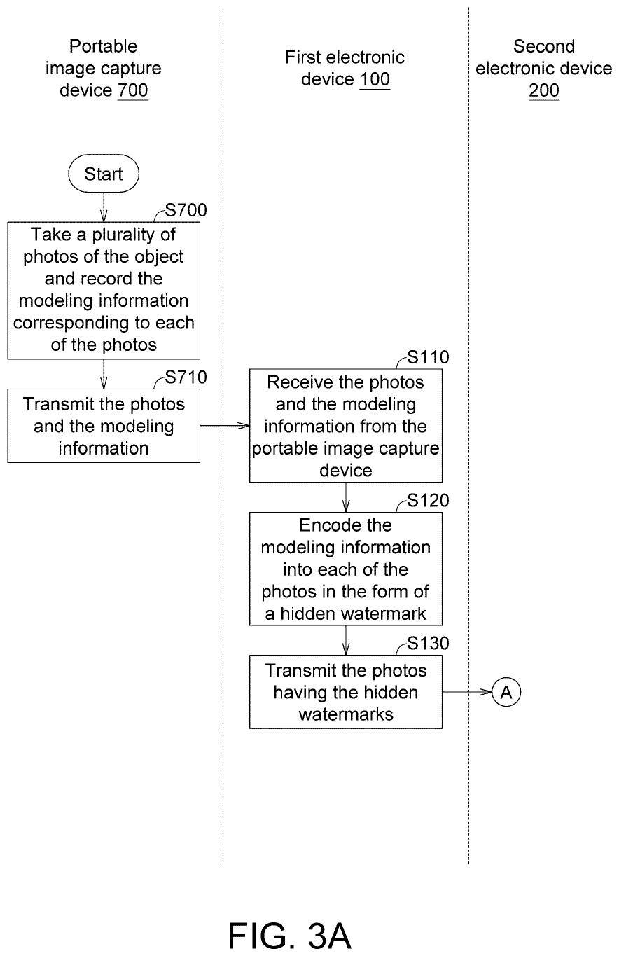

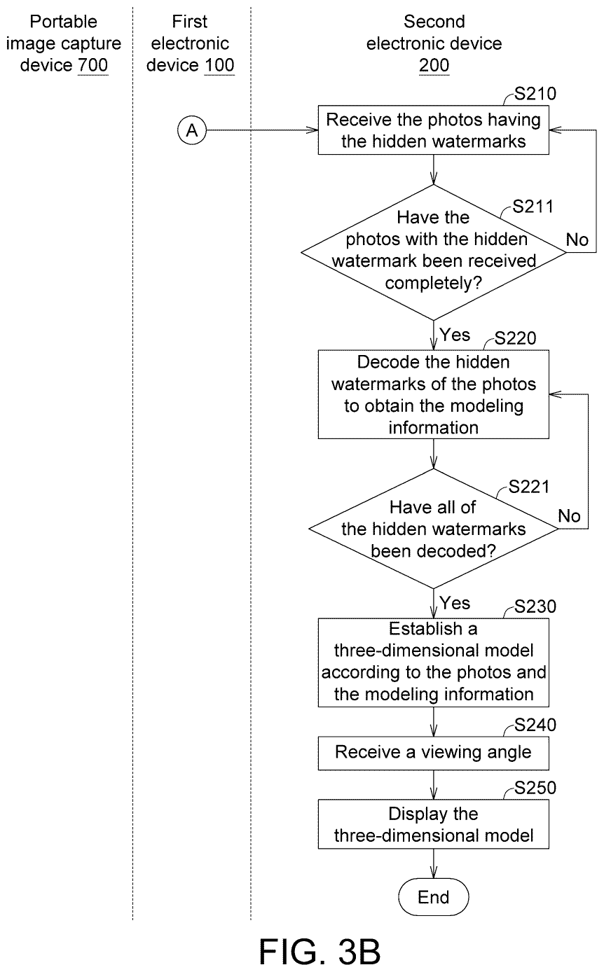

Please refer to FIG. 2 and FIGS. 3A to 3B. FIGS. 3a to 3B are flowcharts of the three-dimensional modeling method for the video conference according to an embodiment of the present disclosure. The three-dimensional modeling method for the video conference includes steps S700, S710, S110 to S130, S210, S211, S220, S221, S230 to S250. In the step S700, as shown in FIG. 1 and FIG. 2, the portable image capture device 700 takes a plurality of photos PT of the object OB and records the modeling information MS corresponding to each of the photos PT. The modeling information MS includes, for example, a shooting direction, a spatial position, an image size, and a shooting parameter.

Next, in the step S710, as shown in FIG. 1 and FIG. 2, the portable image capture device 700 transmits the photos PT and the modeling information MS.

Then, in the step S110, as shown in FIG. 1 and FIG. 2, the first transmission unit 110 of the first electronic device 100 receives the photos PT and the modeling information MS from the portable image capture device 700.

Next, in the step S120, as shown in FIG. 1 and FIG. 2, the watermark encoding unit 120 encodes the modeling information MS into each of the photos PT in the form of a hidden watermark WM. The hidden watermark WM is encoded in the entire range of each of the photos PT. The hidden watermark WM is scattered over several pixels, and the human eye cannot detect the existence of the hidden watermark WM.

Then, in the step S130, as shown in FIG. 1 and FIG. 2, the first transmission unit 110 transmits the photos PT having the hidden watermarks WM.

Next, in the step S210, as shown in FIG. 1 and FIG. 2, the second transmission unit 210 of the second electronic device 200 receives the photos PT having the hidden watermarks WM.

In the step S211, as shown in FIG. 1 and FIG. 2, the second transmission unit 210 determines whether the photos PT with the hidden watermarks WM have been received completely. If the photos PT with the hidden watermarks WM have been received completely, the process proceeds to the step S220; if the photos PT with the hidden watermarks WM have not been received completely, the process returns to the step S210 and continues to receive the photos PT with the hidden watermarks WM.

Next, in the step S220, as shown in FIG. 1 and FIG. 2, the watermark decoding unit 220 decodes the hidden watermarks WM of the photos PT to obtain the modeling information MS. The modeling information MS includes, for example, the shooting direction, spatial position, image size, and shooting parameters.

Then, in the step S221, as shown in FIG. 1 and FIG. 2, the watermark decoding unit 220 determines whether all of the hidden watermarks WM have been decoded. If all of the hidden watermarks WM have been decoded, the process proceeds to the step S230; if there are still some of the hidden watermarks WM that have not been decoded, the process returns to the step S220 to continue decoding the hidden watermarks WM of the photos PT.

In the step S230, as shown in FIG. 1 and FIG. 2, the modeling unit 230 establishes a three-dimensional model MD according to the photos PT and the modeling information MS. In this step, the second electronic device 200 establishes the three-dimensional model MD only after receiving all of the photos PT and decoding all of the modeling information MS.

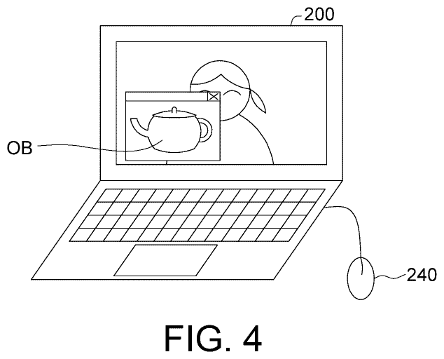

Please refer to FIG. 4, which illustrates the step S240 and the step S250. In the step S240, the display unit 250 receives a viewing angle VA.

In the step S250, as shown in the FIGS. 2 to 4, the display unit 250 of the second electronic device 200 displays the three-dimensional model MD. The user could use the operating unit 240 to control the viewing angle VA of the object OB in the display unit 250. For example, the viewing angle VA of the object OB in the display unit 250 could be controlled by a mouse or a keyboard.

According to the above embodiment, the speaker's first electronic device 100 displays the photos PT of the object OB in various directions and transmits them to the attendee's second electronic device 200 through the network 900. In addition, the modeling information MS is added to the photos PT, so that the second electronic device 200 could quickly establish the three-dimensional model MD. Using the three-dimensional model MD, the attendee could rotate the object OB by the mouse or keyboard to fully see the appearance of each face of the object OB.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A three-dimensional modeling method for a video conference, comprises:
obtaining a plurality of photos of an object and recording a plurality of modeling information corresponding to the photos by a portable image capture device;
transmitting the photos and the modeling information to a first electronic device by the portable image capture device;
encoding each of the modeling information into each of the photos through a hidden watermark by the first electronic device;
transmitting the photos with the hidden watermarks to a second electronic device by the first electronic device;
receiving the photos with the hidden watermarks by the second electronic device;
decoding each of the hidden watermarks of each of the photos to obtain each of the modeling information by the second electronic device;
creating a three-dimensional model according to the photos and the modeling information by the second electronic device; and
displaying the three-dimensional model by the second electronic device.

2. The three-dimensional modeling method for the video conference according to claim 1, wherein each of the modeling information includes a shooting direction, a spatial position, an image size and a shooting parameter.

3. The three-dimensional modeling method for the video conference according to claim 1, wherein each of the hidden watermarks is encoded in an entire range of each of the photos.

4. The three-dimensional modeling method for the video conference according to claim 1, wherein the second electronic device builds the three-dimensional model only after receiving all of the photos with the hidden watermarks.

5. The three-dimensional modeling method for the video conference according to claim 1, wherein the second electronic device displays the three-dimensional model only after the three-dimensional model is completely built.

6. The three-dimensional modeling method for the video conference according to claim 1, wherein the three-dimensional model is stored in the second electronic device.

7. The three-dimensional modeling method for the video conference according to claim 1, wherein the three-dimensional model is displayed according to a viewing angle by the second electronic device, and the viewing angle is adjusted by the second electronic device.

8. The three-dimensional modeling method for the video conference according to claim 1, wherein the three-dimensional model is displayed according to a viewing angle by the second electronic device, and the viewing angle of the three-dimensional model is controlled by a mouse.

9. The three-dimensional modeling method for the video conference according to claim 1, wherein the three-dimensional model is displayed according to a viewing angle by the second electronic device, and the viewing angle of the three-dimensional model is controlled by a keyboard.

10. The three-dimensional modeling method for the video conference according to claim 1, wherein the hidden watermark is scattered over multiple pixels.

11. A video conference system, comprising:
a portable image capture device, used for obtaining a plurality of photos of an object and recording a plurality of modeling information corresponding to the photos;
a first electronic device, comprising:
a first transmission unit, used for receiving the photos and the modeling information from the portable image capture device; and
a watermark encoding unit, used for encoding each of the modeling information into each of the photos through a hidden watermark, wherein the first transmission unit is further used for transmitting the photos with the hidden watermarks; and
a second electronic device, comprising:
a second transmission unit, used for receiving the photos with the hidden watermarks;
a watermark decoding unit, used for decoding each of the hidden watermarks of each of the photos to obtain each of the modeling information;
a modeling unit, used for creating a three-dimensional model according to the photos and the modeling information;
an operating unit, used for providing a viewing angle; and
a display unit, used for displaying the three-dimensional model according to the viewing angle.

12. The video conference system according to claim 11, wherein each of the modeling information includes a shooting direction, a spatial position, an image size and a shooting parameter.

13. The video conference system according to claim 11, wherein each of the hidden watermarks is encoded in an entire range of each of the photos.

14. The video conference system according to claim 11, wherein the modeling unit of the second electronic device builds the three-dimensional model only after the second transmission unit of the second electronic device receives all the of the photos and all of the modeling information.

15. The video conference system according to claim 11, wherein the display unit of the second electronic device displays the three-dimensional model only after the modeling unit of the second electronic device completely builds the three-dimensional model.

16. The video conference system according to claim 11, wherein the three-dimensional model is stored in the second electronic device.

17. The video conference system according to claim 11, wherein the viewing angle of the three-dimensional model is adjusted by the second electronic device.

18. The video conference system according to claim 11, wherein the viewing angle of the three-dimensional model is controlled by a mouse.

19. The video conference system according to claim 11, wherein the viewing angle of the three-dimensional model is controlled by a keyboard.

20. The video conference system according to claim 11, wherein the hidden watermark is scattered over multiple pixels.
